(19) United States
(12) Patent Application Publication
(10) Pub. No.: US 2026/0071955 A1
(43) Pub. Date: Mar. 12, 2026

(54) TERAHERTZ WAVE INTERFEROMETRIC MEASUREMENT DEVICE AND TERAHERTZ WAVE INTERFEROMETRIC MEASUREMENT METHOD

(71) Applicant: HAMAMATSU PHOTONICS K.K., Hamamatsu-shi (JP)

(72) Inventors: Hisanari TAKAHASHI, Shizuoka (JP); Naoya KAWAI, Shizuoka (JP); Kota KATSUYAMA, Shizuoka (JP)

(73) Assignee: HAMAMATSU PHOTONICS K.K., Hamamatsu-shi (JP)

(21) Appl. No.: 19/321,812

(22) Filed: Sep. 8, 2025

(30) Foreign Application Priority Data
Sep. 10, 2024 (JP) 2024-155521

(51) Int. Cl. G01N 21/3581

(52) U.S. Cl. CPC G01N 21/3581; G01N 2201/06113

(57) ABSTRACT

A terahertz wave interferometric measurement device comprising: an optical pulse train generator outputting a periodic first optical pulse train having a first repetition frequency and a periodic second optical pulse train having a second repetition frequency lower than the first repetition frequency; a first converter converting the first optical pulse train into a first terahertz wave; a second converter converting the second optical pulse train into a second terahertz wave; a wave-combining optical system combining the first terahertz wave and the second terahertz wave to generate a third terahertz wave; a trigger generator generating a trigger signal indicating a timing of detecting the third terahertz wave; and a detector having an electron emitter for receiving the third terahertz wave and emitting electrons and an electron multiplier for receiving the electrons and emitting secondary electrons, and detecting the third terahertz wave at the timing indicated by the trigger signal.

### CROSS-REFERENCE TO RELATED APPLICATIONS

This application claims priority to Japanese Patent Application No. 2024-155521, filed on Sep. 10, 2024, the entire contents of which are incorporated herein by reference.

### TECHNICAL FIELD

The present disclosure relates to a terahertz wave interferometric measurement device and a terahertz wave interferometric measurement method.

### BACKGROUND

Terahertz waves are electromagnetic waves in a band between light waves and radio waves and have a unique absorption spectrum for analytes such as medicines not seen in other wavelength bands, and thus are expected to be used for identifying analytes and the like. Various analytical technologies using terahertz waves are known.

Terahertz time domain spectroscopy (THz-TDS) measures a time waveform of terahertz waves transmitted, reflected or totally reflected by an analyte, and performs a Fourier transform on the time waveform of the electric field amplitude of the terahertz waves obtained by this measurement, thereby being able to analyze the analyte (Non-Patent Documents 1 and 2). In this technology, a lock-in amplifier is used to measure the time waveform of terahertz waves.

An analyte can also be analyzed by performing Fourier spectroscopy based on interferometry using terahertz waves according to the same measurement principle as Fourier Transform Infrared Spectroscopy (FTIR) (Non-Patent Document 3). In this technology, a thermal detector is used to detect interference of terahertz waves.
Patent Document 1: Japanese National Publication of International Patent Application No. 2022-538534
Non-Patent Document 1: Jens Neu and Charles A. Schmuttenmaer, “An introduction to terahertz time domain spectroscopy (THz-TDS)”, Journal of Applied Physics, 124, 231101 (2018)
Non-Patent Document 2: Jacob T. Good et al., “A decade-spanning high-resolution asynchronous optical sampling terahertz time-domain and frequency comb spectrometer”, Review of Scientific Instruments, Volume 86, Issue 10, 103107, October 2015
Non-Patent Document 3: M. Yamaguchi and J. Das, “Terahertz wave generation in nitrogen gas using shaped optical pulses”, Journal of the Optical Society of America B, Vol. 26, No. 9, September 2009
Non-Patent Document 4: Yoshiaki Nakajima, Yuya Hata, and Kaoru Minoshima, “High-coherence ultra-broadband bidirectional dual-comb fiber laser”, Optics Express, Vol. 27, No. 5, March 2019
Non-Patent Document 5: Akifumi Asahara and Kaoru Minoshima, “Development of ultrafast time-resolved dual-comb spectroscopy”, Applied Photonics, 2, 041301 (2017)
Non-Patent Document 6: Akifumi Asahara et al., “Dual-comb spectroscopy for rapid characterization of complex optical properties of solids”, Optics Letters, Vol. 41, No. 21, November 2016
Non-Patent Document 7: Ian Coddington, Nathan Newbury, and William Swann, “Dual-comb spectroscopy”, Optica, Vol. 3, No. 4, April
Non-Patent Document 8: Takeshi Yasui et al., “Fiber-based, hybrid terahertz spectrometer using dual fiber combs”, Optics Letters, Vol. 35, No. 10, May 2010
Non-Patent Document 9: Yoshiaki Nakajima, Yuya Hata, and Kaoru Minoshima, “All-polarization-maintaining, polarization-multiplexed, dual-comb fiber laser with a nonlinear amplifying loop mirror”, Optics Express, Volume 27, Issue 10, May 2019
Non-Patent Document 10: Takumi Yumoto et al., “All-polarization-maintaining dual-comb fiber laser with mechanically shared cavity configuration and micro-optic component”, Optics Continuum, Vol. 2, No. 8, August 2023
Non-Patent Document 11: Simon Lehnskov Lange et al, “Ultrafast THz-driven electron emission from metal metasurfaces”, Journal of Applied Photonics, 128, 070901 (2020)
Non-Patent Document 12: Sho Okubo et al., “Ultra-broadband dual-comb spectroscopy across 1.0-1.9 μm”, Applied Physics Express, Volume 8, Number 8, 082402 (2015)
Non-Patent Document 13: Takumi Yumoto et al., “All-polarization-maintaining dual-comb fiber laser with mechanically shared cavity configuration and micro-optic component”, Optics Continuum, Volume 2, Issue 8, pp. 1867-1874 (2023)
Non-Patent Document 14: Nikita Yu et al., “Hybrid Integrated Dual-Microcomb Source”, Physical Review Applied, 18, 034068, September 2022

### SUMMARY

When a lock-in amplifier is used to measure a time waveform of terahertz waves, a long integration time is required by the lock-in amplifier. In addition, when a thermal detector is used to detect interference of terahertz waves, the response of the thermal detector is slow, and thus the measurement time is long. As such, conventional analytical technology using terahertz waves requires a long time for measurement.

An object of the present disclosure is to provide a terahertz wave interferometric measurement device and a terahertz wave interferometric measurement method that are capable of shortening a measurement time.

A terahertz wave interferometric measurement device according to an aspect of the present disclosure includes an optical pulse train generator, a first converter, a second converter, a wave-combining optical system, a trigger generator, and a detector. The optical pulse train generator outputs a periodic first optical pulse train having a first repetition frequency and a periodic second optical pulse train having a second repetition frequency lower than the first repetition frequency. The first converter converts the first optical pulse train into a first terahertz wave. The second converter converts the second optical pulse train into a second terahertz wave. The wave-combining optical system combines the first terahertz wave and the second terahertz wave to generate a third terahertz wave. The trigger generator generates a trigger signal indicating a timing of detecting the third terahertz wave. The detector includes an electron emitter that receives the third terahertz wave and emits electrons, and an electron multiplier that receives the electrons and emits secondary electrons. The detector detects the third terahertz wave at the timing indicated by the trigger signal.

According to the present disclosure, it is possible to provide a terahertz wave interferometric measurement device and a terahertz wave interferometric measurement method capable of shortening a measurement time.

### BRIEF DESCRIPTION OF THE DRAWINGS

FIG. 1 is a diagram schematically illustrating a configuration of a terahertz wave interferometric measurement device according to a first embodiment.

FIG. 2 is a cross-sectional view illustrating an exemplary configuration of a photomultiplier tube.

FIG. 3 is an enlarged partial view illustrating an exemplary configuration of the photomultiplier tube.

FIG. 4 is an enlarged partial view illustrating an exemplary configuration of a metasurface.

FIG. 5 is a graph illustrating a relationship between electric field amplitude and average current.

FIG. 6A is a graph illustrating a relationship between electric field amplitude and an average current value.

FIG. 6B is a graph illustrating a relationship between an electric field amplitude and a peak current value.

FIG. 7 is a flowchart illustrating a terahertz wave interferometric measurement method according to the first embodiment.

FIG. 8 is a diagram schematically illustrating a configuration of a terahertz wave interferometric measurement device according to the second embodiment.

FIG. 9 is a cross-sectional view illustrating an exemplary configuration of an image intensifier.

FIG. 10 is a drawing schematically illustrating a configuration of an optical pulse train generator according to a modification.

### DETAILED DESCRIPTION

Specific examples of the present disclosure will be described below with reference to the drawings. Note that the present invention is not limited to these examples, but is defined by the claims, and is intended to encompass all modifications within the meaning and scope equivalent to the claims. In the following description, the same elements in the description of the drawings are given the same reference numerals, and duplicate descriptions are omitted.

### First Embodiment

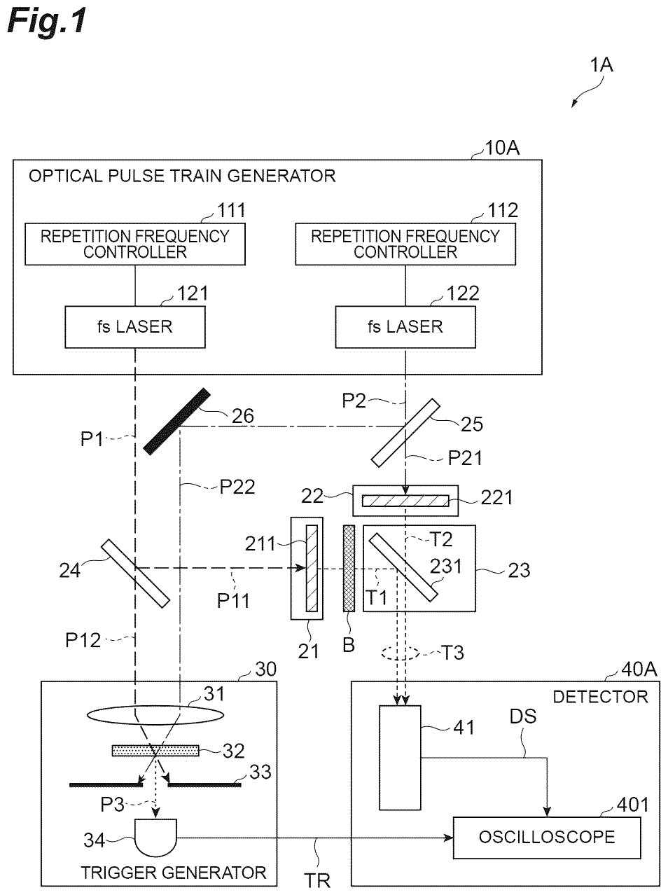

FIG. 1 is a diagram schematically illustrating a configuration of a terahertz wave interferometric measurement device 1A according to the first embodiment of the present disclosure. The terahertz wave interferometric measurement device 1A of this embodiment can be used to perform, for example, dual-comb spectroscopy using terahertz waves. As illustrated in FIG. 1, the terahertz wave interferometric measurement device 1A of this embodiment includes an optical pulse train generator 10A, a first converter 21, a second converter 22, a wave-combining optical system 23, beam splitters 24 and 25, a mirror 26, a trigger generator 30, and a detector 40A.

The optical pulse train generator 10A outputs a periodic first optical pulse train P1 (first frequency comb) having the first repetition frequency frep1. At the same time, the optical pulse train generator 10A outputs a periodic second optical pulse train P2 (second frequency comb) having a second repetition frequency frep2 slightly lower than the first repetition frequency frep1. The wavelength bands of the first optical pulse train P1 and the second optical pulse train P2 are within a range from 500 nm to 3000 nm when a fiber laser having an excitation medium such as erbium, ytterbium, thulium, or neodymium and a wavelength conversion method such as second harmonic generation are used.

The optical pulse train generator 10A of this embodiment includes two repetition frequency controllers 111 and 112, and two femtosecond lasers 121 and 122 synchronized with each other. The femtosecond laser 121 generates and outputs the first optical pulse train P1. The femtosecond laser 122 generates and outputs the second optical pulse train P2. The femtosecond lasers 121 and 122 are, for example, fiber lasers amplifying light using optical fibers. Time widths of optical pulses included in the first optical pulse train P1 and the second optical pulse train P2 are, for example, within a range from 10 fs to 10 ps. The first repetition frequency frep1 and the second repetition frequency frep2 are, for example, within a range from 1 MHz to 1 GHZ, or within a range from 1 MHz to 250 MHZ, or 1 MHz or less. The difference between the first repetition frequency frep1 and the second repetition frequency frep2 is, for example, 100 Hz or more.

The difference between the first repetition frequency frep1 and the second repetition frequency frep2 is defined as Δfrep. Furthermore, a measurement band Δν (Nyquist spectrum band) is defined as Δν=(frep1×frep2)/2Δfrep. The first repetition frequency frep1 and the second repetition frequency frep2 are set so that the measurement band Δν is larger than the spectral sensitivity bandwidth of a photomultiplier tube 41 (described later). The spectral sensitivity bandwidth of the photomultiplier tube 41 is, for example, 2 THz.

The repetition frequency controller 111 is electrically connected to the femtosecond laser 121 and controls the first repetition frequency frep1. The repetition frequency controller 112 is electrically connected to the femtosecond laser 122 and controls the second repetition frequency frep2. The first repetition frequency frep1 and the second repetition frequency frep2 can each be varied by the repetition frequency controllers 111 and 112, respectively.

A beam splitter 24 is optically coupled to the femtosecond laser 121. The beam splitter 24 receives the first optical pulse train P1 from the femtosecond laser 121, splits the first optical pulse train P1 into two optical paths, and outputs the resulting pulse trains. The beam splitter 25 is optically coupled to the femtosecond laser 122. The beam splitter 25 receives the second optical pulse train P2 from the femtosecond laser 122, splits the second optical pulse train P2 into two optical paths, and outputs the resulting pulse trains.

The first converter 21 is optically coupled to the femtosecond laser 121 via the beam splitter 24. The first converter 21 receives a first optical pulse train P11, which is one of two first optical pulse trains split by the beam splitter 24, and converts the first optical pulse train P11 into a first terahertz wave T1. The first converter 21 includes a terahertz wave generation element 211. The second converter 22 receives a second optical pulse train P21, which is one of two second optical pulse trains split by the beam splitter 25, and converts the second optical pulse train P21 into a second terahertz wave T2. The second converter 22 includes a terahertz wave generation element 221. The terahertz wave generation elements 211 and 221 are, for example, photoconductive antennas. Alternatively, the terahertz wave generation elements 211 and 221 may be nonlinear crystals, for example, ZnTe. The terahertz wave generation element 211 converts the incident first optical pulse train P11 into the first terahertz wave T1. The first terahertz wave T1 includes a periodic pulse train having the first repetition frequency frep1. The terahertz wave generation element 221 converts the incident second optical pulse train P21 into the second terahertz wave T2. The second terahertz wave T2 includes a periodic pulse train having the second repetition frequency frep2.

The wave-combining optical system 23 is optically coupled to both the first converter 21 and the second converter 22. The wave-combining optical system 23 combines the first terahertz wave T1 and the second terahertz wave T2 to generate a third terahertz wave T3. In FIG. 1, the first terahertz wave T1 after combining is illustrated as being separated from the second terahertz wave T2 for ease of understanding, but in reality, the first terahertz wave T1 after combining travels on the same optical axis as that of the second terahertz wave T2. The wave-combining optical system 23 includes, for example, a half mirror 231.

An object to be measured B is arranged on an optical path of the first terahertz wave T1 between the first converter 21 and the wave-combining optical system 23, or on an optical path of the second terahertz wave T2 between the second converter 22 and the wave-combining optical system 23.

The trigger generator 30 generates a trigger signal TR indicating the timing of detecting the third terahertz wave T3. The trigger generator 30 includes, for example, a lens 31, a nonlinear crystal 32, an aperture 33, and a photodetector 34.

The lens 31 is optically coupled to the femtosecond laser 121 via the beam splitter 24. In addition, the lens 31 is optically coupled to the femtosecond laser 122 via the beam splitter 25 and the mirror 26. The lens 31 receives a first optical pulse train P12, which is the other one of the two first optical pulse trains split by the beam splitter 24. At the same time, the lens 31 receives a second optical pulse train P22, which is the other one of the two second optical pulse trains split by the beam splitter 25. An incidence point of the first optical pulse train P12 on the lens 31 and an incidence point of the second optical pulse train P22 on the lens 31 are separated from each other with an optical axis of the lens 31 therebetween. As a result, the first optical pulse train P12 and the second optical pulse train P22 emitted from the lens 31 intersect each other at a certain single point.

The nonlinear crystal 32 is arranged at a position coinciding with a point where the first optical pulse train P12 and the second optical pulse train P22 intersect each other. The nonlinear crystal 32 generates difference-frequency light P3 from the first optical pulse train P12 and the second optical pulse train P22. The nonlinear crystal 32 may generate sum-frequency light from the first optical pulse train P12 and the second optical pulse train P22. The aperture 33 is arranged at a position such that the nonlinear crystal 32 is interposed between the aperture 33 and the lens 31. The difference-frequency light P3 or the sum-frequency light generated by the nonlinear crystal 32 passes through the aperture 33. The first optical pulse train P12 and the second optical pulse train P22 transmitted through the nonlinear crystal 32 are blocked by the aperture 33.

The photodetector 34 detects the difference-frequency light P3 or the sum-frequency light from the nonlinear crystal 32 and generates a detection signal indicating arrival timing of the difference-frequency light P3 or the sum-frequency light. The trigger generator 30 outputs the detection signal or a signal generated based on the detection signal as a trigger signal TR.

The configuration of the trigger generator 30 is not limited to the above configuration. For example, the photodetector 34 may detect the first optical pulse train P12 or the second optical pulse train P22 instead of the difference-frequency light P3 or the sum-frequency light. The trigger generator 30 may then output the detection signal or the signal generated based on the detection signal as the trigger signal TR.

The detector 40A detects the third terahertz wave T3 at the timing indicated by the trigger signal TR. The detector 40A of this embodiment includes the photomultiplier tube 41 and a time waveform measuring instrument (oscilloscope) 401. The photomultiplier tube 41 generates an electrical signal DS according to the intensity of the third terahertz wave T3. The time waveform measuring instrument 401 is electrically connected to the photomultiplier tube 41 and receives the electrical signal DS from the photomultiplier tube 41. The time waveform measuring instrument 401 is electrically connected to the photodetector 34 of the trigger generator 30 and receives the trigger signal TR from the photodetector 34. The time waveform measuring instrument 401 repeatedly measures a magnitude of the electrical signal DS output from the photomultiplier tube 41, in other words, a magnitude of a pulse included in the third terahertz wave T3, in accordance with the timing indicated by the trigger signal TR. Thereby, the time waveform measuring instrument 401 acquires a time waveform of a pulse included in the first terahertz wave T1 transmitted through the object to be measured B, or a time waveform of a pulse included in the second terahertz wave T2 transmitted through the object to be measured B.

Data related to the time waveform acquired by the detector 40A is provided to a computer (not illustrated). Based on the time waveform, the computer performs Fourier spectroscopic analysis on the object to be measured B. However, since the relationship between the output current from the photomultiplier tube 41 and the electric field amplitude of the third terahertz wave T3 is nonlinear, calculation is performed taking this nonlinearity into consideration.

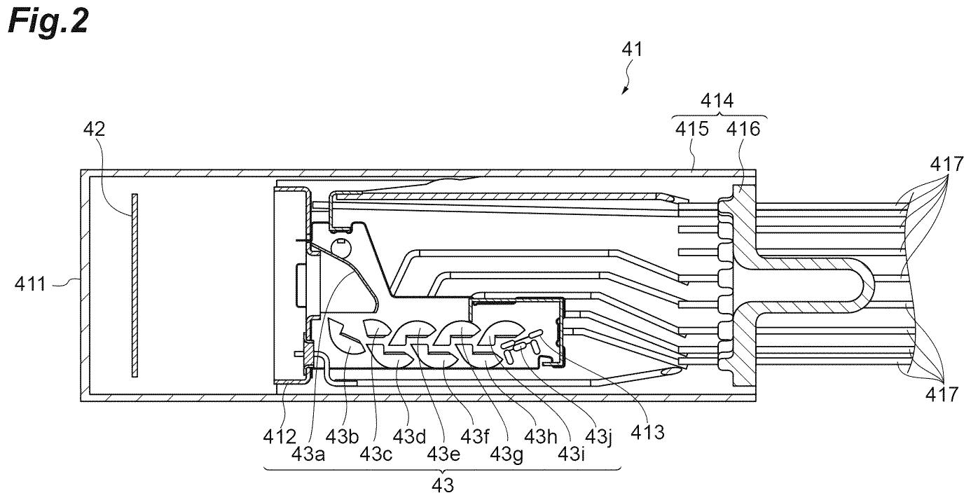

FIG. 2 is a cross-sectional view illustrating an exemplary configuration of the photomultiplier tube 41. The photomultiplier tube 41 includes an electron emitter 42, an electron multiplier 43, an electron collector 413, a housing 414, and a plurality of wires 417. The housing 414 includes a bulb 415 and a stem 416. The bulb 415 includes a window 411 through which a terahertz wave passes. The electron emitter 42 emits electrons in response to incidence of the third terahertz wave T3.

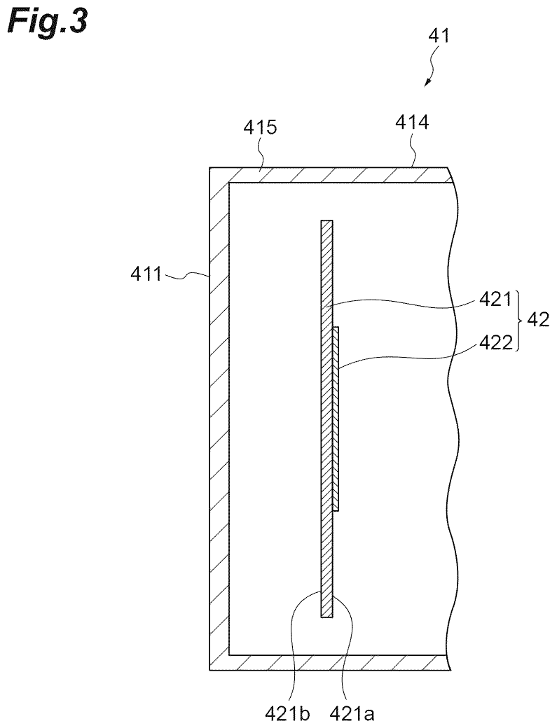

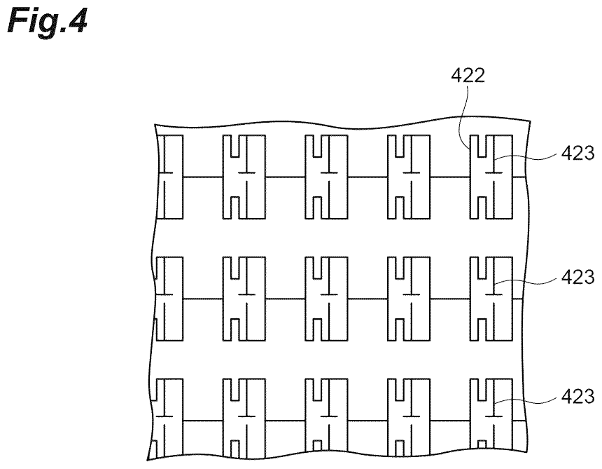

FIG. 3 is an enlarged partial view illustrating an exemplary configuration of the photomultiplier tube 41. The electron emitter 42 includes a substrate 421 and a metasurface 422. The substrate 421 includes a main surface 421a facing the electron multiplier 43 and a main surface 421b facing the window 411. The third terahertz wave T3 transmitted through the window 411 is incident on the main surface 421b of the substrate 421. The metasurface 422 is provided on the main surface 421a. The third terahertz wave T3 transmits through the substrate 421 and is incident on the metasurface 422. The metasurface 422 is included in an oxide layer or a metal layer that is patterned on the main surface 421a of the substrate 421. The oxide layer is, for example, titanium dioxide (TiO2). The metal layer is, for example, gold (Au). FIG. 4 is an enlarged partial view illustrating an exemplary configuration of the metasurface 422. In this example, the metal layer included in the passive type metasurface 422 forms a plurality of antennas 423 on the main surface 421a. As sizes of the antennas 423 decrease, the antennas 423 become sensitive to terahertz waves having shorter wavelengths, i.e., terahertz waves having higher frequencies. By changing the structure of the antennas 423, the metasurface 422 can cope with a frequency band of, for example, about 0.01 THz to 10 THz or 10 THz to 50 THz. The metasurface 422 emits electrons, the quantity of which corresponds to the intensity of the third terahertz wave T3.

Referring again to FIG. 2, the electron multiplier 43 receives electrons emitted from the electron emitter 42 and emits multiplied secondary electrons. The electron multiplier 43 includes a focusing electrode 412 that focuses electrons emitted from the metasurface 422, and a plurality of stages of so-called line focus type dynodes 43a to 43j. The dynodes 43a to 43j multiply electrons passing through an opening of the focusing electrode 412 in response to a potential applied through the wires 417. The electrons are multiplied and sequentially transferred from the first stage dynode 43a to the last stage dynode 43j. The electron collector 413 collects the electrons multiplied by the electron multiplier 43. The collected electrons are output as a current signal from the electron collector 413 through the wires 417. The current signal is converted into a voltage signal by a circuit (not illustrated), and the voltage signal is output to the time waveform measuring instrument 401 as the electrical signal DS (see FIG. 1).

The input/output characteristics of the photomultiplier tube 41 are not linear. An output value from the photomultiplier tube 41 may be described by a polynomial with electric field amplitude E of an electromagnetic wave incident on the photomultiplier tube 41 as a variable, or may be described using Equation (1) below that represents efficiency of electron emission on the metasurface 422 (see Non-Patent Document 11 for details). This equation represents a relationship between a current J emitted from the metasurface 422 and the electric field amplitude E of the incident terahertz wave, and is referred to as the Fowler-Nordheim relation (hereinafter referred to as “FN formula”).

$$\begin{matrix}[ Equation 1 ] & \\ J ( E ) = \frac{{a}_{F N}}{{t}_{F}^{2}} \frac{{( β E )}^{2}}{Φ} exp ( - \frac{{v}_{F} {b}_{F N} {Φ}^{3 / 2}}{β E} ) & ( 1 )\end{matrix}$$

In this FN formula, each of a_{FN} and b_{FN} is referred to as an FN constant, which is a certain constant value. B is the field enhancement factor, which is about 400 in Non-Patent Document 11. Φ is a work function of a material of the metasurface 422 of the electron emitter 42, which is 3.5 eV for gold (Au). Each of t_{F} and ν_{F} is a constant. When the electric field amplitude of the incident terahertz wave is not large, a value of each of t_{F} and ν_{F} may be set to 1. This FN formula represents a relationship between the current J emitted from the electron emitter 42 of the photomultiplier tube 41 and the electric field amplitude E of the incident terahertz wave, and a relationship between an output current from the photomultiplier tube 41 and the electric field amplitude E of the incident terahertz wave can be similarly represented.

It is necessary to determine the respective values of a_{FN} and b_{FN} in the FN formula. To this end, the respective values of a_{FN} and b_{FN} can be obtained by setting the electric field amplitude E of the incident terahertz wave to various values, measuring output currents of the photomultiplier tube 41, and performing a fitting process using these measured currents.

When the third terahertz wave T3 is incident on the photomultiplier tube 41, an average value J_{avg} of the output current from the photomultiplier tube 41 can be obtained according to the following equation.

$${J}_{a v g} ( E ) = J ( E ) \times {f}_{r e p} \times C E \times G$$

Here, fᵣₑₚ is the repetition frequency of pulses included in the third terahertz wave T3, CE is the collection efficiency, and G is the gain of the electron multiplier 43. In order to accurately detect the third terahertz wave T3 in the photomultiplier tube 41, the average current J_{avg} preferably satisfies Jₘᵢₙ<J_{avg}<Jₛₐₜ. Here, Jₘᵢₙ is a value determined by the magnitude of the dark current. Jₛₐₜ is a value determined by the DC linearity (the limit for maintaining linearity between input and output) of the electron multiplier 43.

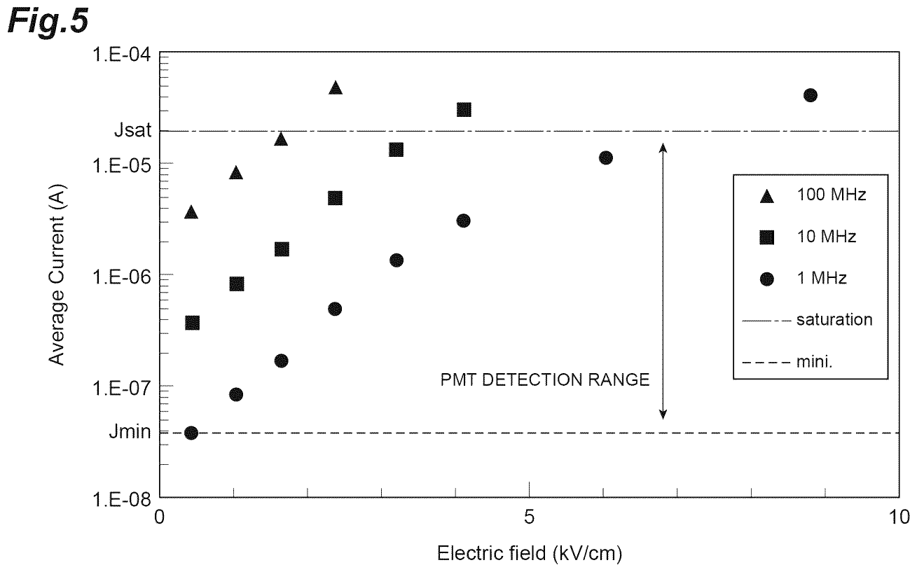

FIG. 5 is a graph illustrating a relationship between the electric field amplitude E and the average current J_{avg}. In FIG. 5, the horizontal axis represents the electric field amplitude E (kV/cm), and the vertical axis represents the average current J_{avg} (A). The triangular plot, the square plot, and the circular plot indicate cases where the repetition frequency fᵣₑₚ is 100 MHZ, 10 MHZ, and 1 MHz, respectively. In the figure, a dash-dotted line indicates the limit of DC linearity, i.e., the saturation level (Jₛₐₜ), and a dashed line indicates the lower limit Jₘᵢₙ based on the magnitude of the dark current. Referring to FIG. 5, it can be seen that the measurement range is widest when the repetition frequency fᵣₑₚ is 1 MHz, and the measurement range becomes narrower as the repetition frequency fᵣₑₚ increases. In this example, the measurement range of the electron multiplier 43 is approximately 38 nA to 20 ρA. From the graph illustrated in FIG. 5, the repetition frequency fᵣₑₚ may be 100 MHz or less, 10 MHz or less, or 1 MHz or less. Therefore, the first repetition frequency frep1 and the second repetition frequency frep2, which are extremely close to or equal to the repetition frequency fᵣₑₚ, may also be 100 MHz or less, 10 MHz or less, or 1 MHz or less.

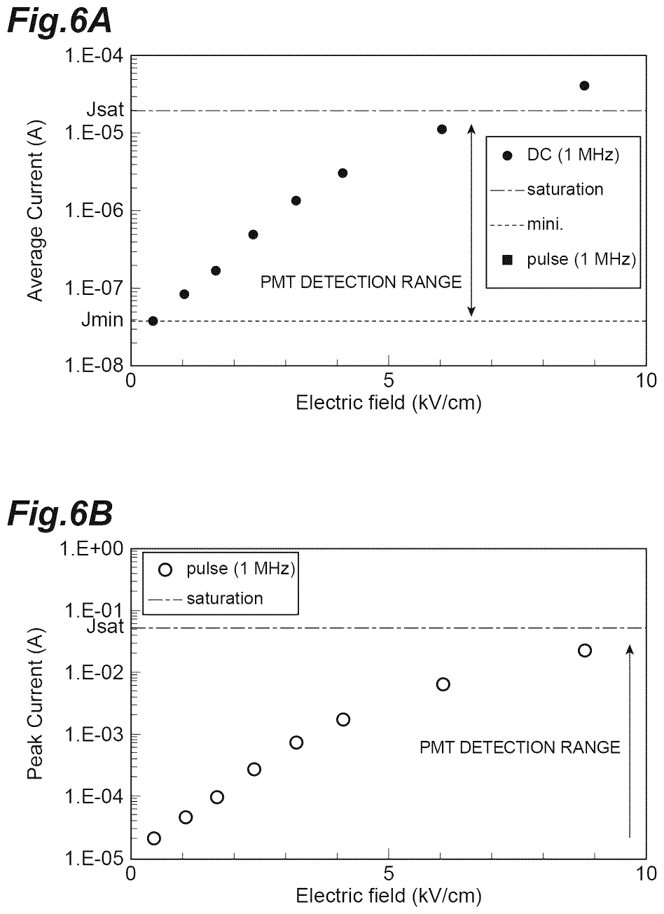

FIG. 6A is a graph illustrating a relationship between an electric field amplitude and an average current value when the terahertz wave incident on the photomultiplier tube 41 is a continuous wave. In FIG. 6A, the horizontal axis represents electric field amplitude (kV/cm), and the vertical axis represents average current (A). FIG. 6B is a graph illustrating a relationship between electric field amplitude and a peak current value when a terahertz wave is incident on the photomultiplier tube 41 includes repetitive pulses having a repetition frequency of 1 MHz. In FIG. 6B, the horizontal axis represents electric field amplitude (kV/cm), and the vertical axis represents peak current (A). The saturation level of the photomultiplier tube 41 also differs depending on whether the incident terahertz wave is a continuous wave or a pulse. For example, in the examples illustrated in FIG. 6A and FIG. 6B, the electric field amplitude reaching the saturation level is lower when the incident terahertz wave is a continuous wave than when the incident terahertz wave is a pulse wave. Therefore, the average current J_{avg} is limited by the saturation level (Jₛₐₜ) calculated from the current J when the terahertz wave is a continuous wave. Conversely, if the electric field amplitude reaching the saturation level is lower when the incident terahertz wave is a pulse wave than when the incident terahertz wave is a continuous wave, the average current J_{avg} is limited by the saturation level (Jₛₐₜ) calculated from the average current J_{avg} for the pulsed terahertz wave.

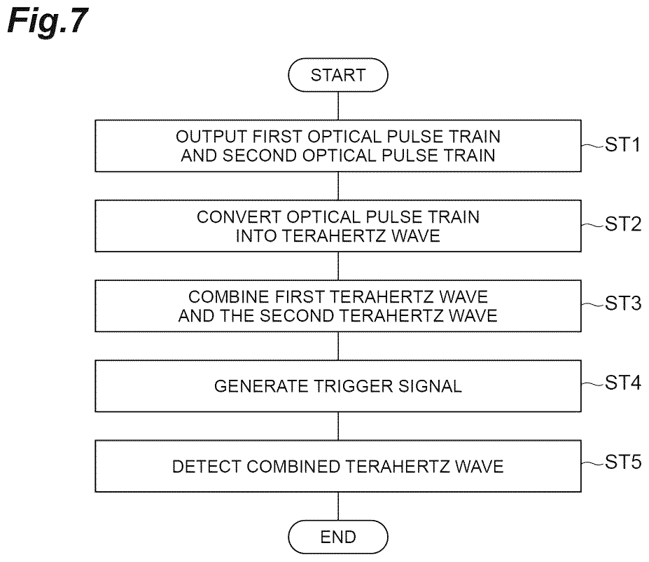

FIG. 7 is a flowchart illustrating a terahertz wave interferometric measurement method according to the first embodiment of the present disclosure. As illustrated in FIG. 7, the terahertz wave interferometric measurement method of this embodiment includes steps ST1 to ST5.

In step ST1, the optical pulse train generator 10A is used to output the periodic first optical pulse train P1 having the first repetition frequency frep1, and to output the periodic second optical pulse train P2 having the second repetition frequency frep2 lower than the first repetition frequency frep1. In step ST2, the first optical pulse train P1 is converted into the first terahertz wave T1 using the first converter 21, and the second optical pulse train P2 is converted into the second terahertz wave T2 using the second converter 22. In step ST3, the wave-combining optical system 23 is used to combine the first terahertz wave T1 and the second terahertz wave T2, thereby generating the third terahertz wave T3. In step ST4, the trigger generator 30 is used to generate the trigger signal TR indicating the timing of detecting the third terahertz wave T3. In step ST5, the third terahertz wave T3 is detected at the timing indicated by the trigger signal TR using the photomultiplier tube 41 having the electron emitter 42 that receives the third terahertz wave T3 and emits electrons, and the electron multiplier 43 that receives the electrons and emits secondary electrons.

Effects obtained by the terahertz wave interferometric measurement device 1A and the terahertz wave interferometric measurement method of the embodiment described above will be described. According to the terahertz wave interferometric measurement device 1A and the terahertz wave interferometric measurement method of this embodiment, dual-comb spectroscopy using terahertz waves can be effectively performed. That is, the first terahertz wave T1 and the second terahertz wave T2 are generated from the first optical pulse train P1 and the second optical pulse train P2, respectively, having repetition frequencies different from each other. Therefore, the first terahertz wave T1 and the second terahertz wave T2 are also different from each other in their repetition frequencies. The first terahertz wave T1 and the second terahertz wave T2 are combined by the wave-combining optical system 23, thereby obtaining the third terahertz wave T3 including a pulse waveform obtained by temporally extending the pulse waveform of the first terahertz wave T1 or the second terahertz wave T2. Then, the third terahertz wave T3 is detected using the detector 40A capable of detecting the third terahertz wave T3, in other words, having sensitivity to a wavelength band including a terahertz wave. In this way, it is possible to know a time waveform of a pulse included in the third terahertz wave T3, and to perform Fourier spectroscopic analysis on the object to be measured B based on the time waveform.

In addition, in this embodiment, the detector 40A includes the electron emitter 42 that receives the third terahertz wave T3 and emits electrons, and the electron multiplier 43 that receives the electrons and emits secondary electrons. In this way, it is possible to detect the time waveform of the pulse included in the third terahertz wave T3 in a short time (for example, less than 1 ms) without using a time-consuming conventional method, such as a lock-in amplifier or a thermal detector. Therefore, according to this embodiment, a measurement time can be significantly shortened compared to the conventional method.

A conventional measurement device has problems in that it is difficult to confirm interference between terahertz waves, the detection area of a terahertz wave detection element is small, being 1 mm or less, and sensitivity of a terahertz wave detector (e.g., a semiconductor element such as a Schottky barrier diode) sharply drops at 1 THz or more. Although a thermal detector exists, the thermal detector has a low response speed, and cannot be used for, for example, a femtosecond laser having a repetition frequency of 50 MHz. Therefore, in the conventional measurement device, a method of making terahertz waves interfere with each other was not used.

Meanwhile, the photomultiplier tube 41 for detecting terahertz waves used in this embodiment has a response speed of 100 MHz or more, is sensitive to a frequency band of 1 THz or more, and has the detection area of, for example, 6 mm or more. Therefore, the photomultiplier tube 41 can be considered to be suitable for interferometric measurement for terahertz waves.

As in this embodiment, the detector 40A may have the photomultiplier tube 41 including the plurality of stages of dynodes 43a to 43j as the electron multiplier 43. In this case, when secondary electrons emitted from the dynode 43j at the final stage are converted into a voltage signal, a signal indicating a time waveform of a pulse included in the third terahertz wave T3 can be obtained. Therefore, the time waveform of the pulse included in the third terahertz wave T3 can be detected in a shorter time. In addition, simple interferometric measurement using a single element can be performed, and is useful for, for example, spectroscopic measurement or tomographic measurement, so-called THz coherence tomography (THz-OCT).

As in this embodiment, both the first repetition frequency frep1 and the second repetition frequency frep2 may be within a range from 1 MHz to 1 GHZ, or 1 MHz to 250 MHz. When both the first repetition frequency frep1 and the second repetition frequency frep2 are 1 MHz or more, the measurement time can be sufficiently shortened. Because both the first repetition frequency frep1 and the second repetition frequency frep2 are 1 GHz or less, the first optical pulse train P1 and the second optical pulse train P2 can be generated using, for example, a fiber laser.

Upper limits (1 GHz or 250 MHz) of the first repetition frequency frep1 and the second repetition frequency frep2 result from the response speed of the photomultiplier tube 41 of the detector 40A. The response speed of the photomultiplier tube 41 is almost determined by the response speed of the electron multiplier 43. The photomultiplier tube 41 outputs a pulse current having a time width (full width at half maximum) of, for example, 2 ns in response to the input of a terahertz wave pulse having a time width (full width at half maximum) of about 1 ps. In this case, the maximum value of the repetition frequency to which the photomultiplier tube 41 can respond is 1/(2 ns×2)=250 MHz. When the photomultiplier tube 41 having the electron multiplier 43 that can respond even faster is used, the photomultiplier tube 41 can output a pulse current having a time width (full width at half maximum) of, for example, 0.5 ns in response to the input of a terahertz wave pulse having a time width (full width at half maximum) of about 1 ps. In this case, the maximum value of the repetition frequency to which the photomultiplier tube 41 can respond is 1 GHz.

As in this embodiment, the trigger generator 30 may include the nonlinear crystal 32 and the photodetector 34. The nonlinear crystal 32 generates the difference-frequency light P3 or the sum-frequency light from the first optical pulse train P1 and the second optical pulse train P2. The photodetector 34 detects the difference-frequency light P3 or the sum-frequency light from the nonlinear crystal 32 to generate a detection signal. The trigger generator 30 may use the detection signal or a signal based on the detection signal as the trigger signal TR. In this case, the trigger generator 30 capable of generating the trigger signal TR with high timing accuracy can be easily configured.

As in this embodiment, the difference Δfrep between the first repetition frequency frep1 and the second repetition frequency frep2 may be 100 Hz or more. In this case, the measurement time can be sufficiently shortened.

As in this embodiment, the measurement band Δν may be greater than the spectral sensitivity bandwidth of the detector 40A. As the difference Δfrep in repetition frequency increases, the measurement time becomes shorter, but as the difference Δfrep in repetition frequency increases, the measurement band Δν (Nyquist spectrum band) becomes narrower. Therefore, there is a trade-off between the measurement time and the measurement band Δν, and as the measurement time become shorter, the measurement band Δν becomes narrower. By reducing Δfrep to such an extent that the measurement band Δν is greater than the spectral sensitivity bandwidth of the detector 40A, the time waveform of the pulse included in the third terahertz wave T3 can be suitably detected.

### Second Embodiment

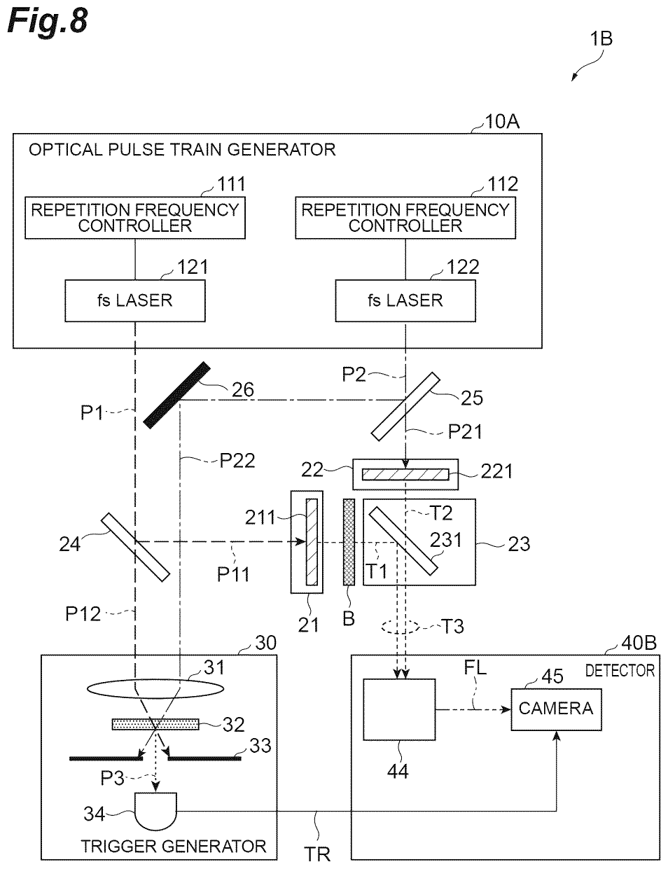

FIG. 8 is a diagram schematically illustrating a configuration of a terahertz wave interferometric measurement device 1B according to the second embodiment of the present disclosure. The terahertz wave interferometric measurement device 1B of this embodiment differs from the terahertz wave interferometric measurement device 1A of the first embodiment in that it includes a detector 40B instead of the detector 40A, and is the same as the terahertz wave interferometric measurement device 1A of the first embodiment in other respects. The detector 40B detects the third terahertz wave T3 at the timing indicated by the trigger signal TR. The detector 40B of this embodiment includes an image intensifier 44 and an imager (camera) 45.

The image intensifier 44 generates a fluorescent image FL according to a two-dimensional intensity distribution of the third terahertz wave T3. The imager 45 is optically coupled to the image intensifier 44 and receives the fluorescent image FL from the image intensifier 44. The imager 45 is electrically connected to the photodetector 34 of the trigger generator 30 and receives the trigger signal TR from the photodetector 34. The imager 45 repeatedly captures the fluorescent image FL output from the image intensifier 44 in accordance with the timing indicated by the trigger signal TR. In this way, the imager 45 two-dimensionally acquires a time waveform of a pulse included in the first terahertz wave T1 transmitted through the object to be measured B or a time waveform of a pulse included in the second terahertz wave T2 transmitted through the object to be measured B.

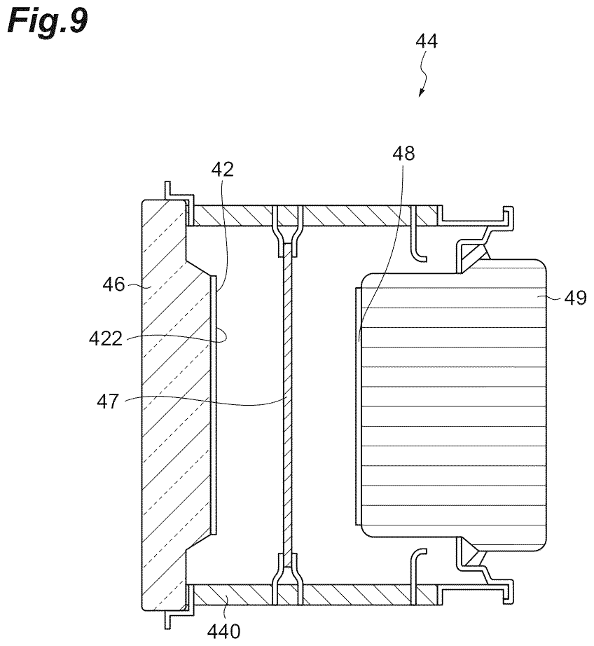

FIG. 9 is a cross-sectional view illustrating an exemplary configuration of the image intensifier 44. The image intensifier 44 includes the electron emitter 42, an entrance window 46, an electron multiplier 47, a phosphor 48, a fiber optic plate (FOP) 49, and a housing 440. The entrance window 46 seals one end of the cylindrical housing 440, and the FOP 49 seals the other end of the cylindrical housing 440. The entrance window 46 transmits at least a part of the third terahertz wave T3. The electron emitter 42 is fixed to the rear surface of the entrance window 46, that is, the surface opposite to the surface on which the third terahertz wave T3 is incident. The configuration of the electron emitter 42 is the same as that of the first embodiment described above. The electron multiplier 47 of this embodiment is a microchannel plate (MCP). The MCP includes a plurality of holes (capillaries) arranged two-dimensionally, each of which multiplies electrons passing therethrough.

The phosphor 48 is arranged at a position interposing the electron multiplier 47 between the phosphor 48 and the electron emitter 42. The phosphor 48 converts secondary electrons emitted from the MCP into a fluorescent image. The phosphor 48 is formed, for example, by applying a fluorescent material to an end face of the FOP 49. The FOP 49 guides the fluorescent image output from the phosphor 48 to the outside of the image intensifier 44 while maintaining an image shape. This fluorescent image is output from the image intensifier 44 as the fluorescent image FL illustrated in FIG. 8.

In this embodiment, the first repetition frequency frep1 and the second repetition frequency frep2 are, for example, within a range from 1 MHz to 500 MHz, or within a range from 1 MHz to 250 MHZ, or 1 MHz or less. The difference between the first repetition frequency frep1 and the second repetition frequency frep2 is, for example, 100 Hz or more, as in the first embodiment. The first repetition frequency frep1 and the second repetition frequency frep2 are set so that the measurement band Δν is greater than the spectral sensitivity bandwidth of the image intensifier 44. The spectral sensitivity bandwidth of the image intensifier 44 is, for example, 2 THz.

In the terahertz wave interferometric measurement method according to this embodiment, in step ST5 of FIG. 7, the third terahertz wave T3 is detected at the timing indicated by the trigger signal TR using the image intensifier 44 having the electron emitter 42 that receives the third terahertz wave T3 and emits electrons, and the electron multiplier 47 that receives the electrons and emits secondary electrons. Steps ST1 to ST4 are similar to those in the first embodiment.

According to this embodiment, similarly to the first embodiment, dual-comb spectroscopy using terahertz waves can be effectively performed. In addition, in this embodiment, the detector 40B includes the electron emitter 42 that receives the third terahertz wave T3 and emits electrons, and the electron multiplier 47 that receives the electrons and emits secondary electrons. In this way, it is possible to detect the time waveform of the pulse included in the third terahertz wave T3 in a short time without using a time-consuming conventional method, such as a lock-in amplifier or a thermal detector. Therefore, in this embodiment, the measurement time can be significantly reduced compared to the conventional method. Furthermore, according to this embodiment, a signal indicating the time waveform of the pulse included in the third terahertz wave T3 can be obtained two-dimensionally from an optical intensity distribution indicated by image data obtained in the imager 45. Therefore, spectroscopic measurement for a region having a certain spread in the object to be measured B can be performed in a single measurement.

As in this embodiment, both the first repetition frequency frep1 and the second repetition frequency frep2 may be within a range from 1 MHz to 500 MHz. When both the first repetition frequency frep1 and the second repetition frequency frep2 are 1 MHz or more, the measurement time can be sufficiently shortened. Because both the first repetition frequency frep1 and the second repetition frequency frep2 are 500 MHz or less, the measurement time can be shortened while taking into account the relaxation time of the phosphor 48.

An upper limit (500 MHZ) of values of the first repetition frequency frep1 and the second repetition frequency frep2 is attributable to the relaxation time of the phosphor 48 included in the image intensifier 44 of the detector 40B. The relaxation time is, for example, 1 ms, or 0.2 us to 0.4 μs. Some recently developed high-speed phosphors have a relaxation time of 1 ns. When the relaxation time is 1 ns, the maximum value of the repetition frequency to which the image intensifier 44 can respond is 1/(1 ns×2)=500 MHZ.

### [Modification]

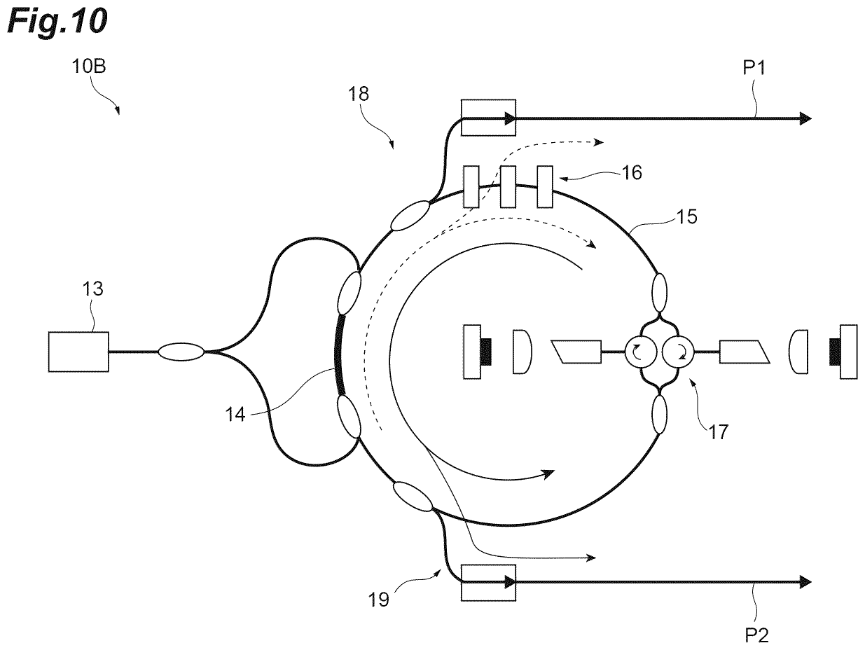

FIG. 10 is a drawing schematically illustrating a configuration of an optical pulse train generator 10B according to a modification. The terahertz wave interferometric measurement device 1A of the first embodiment and the terahertz wave interferometric measurement device 1B of the second embodiment described above may include the optical pulse train generator 10B of this modification instead of the optical pulse train generator 10A.

The optical pulse train generator 10B is a bidirectional-oscillation type dual-comb laser light source that outputs the first optical pulse train P1 and the second optical pulse train P2. The optical pulse train generator 10B outputs the first optical pulse train P1 generated by oscillating clockwise (CW) and the second optical pulse train P2 generated by oscillating counterclockwise (CCW). In the optical pulse train generator 10B, for example, light from a light source 13 such as a laser diode is sent to a doped fiber 14 such as an erbium-doped fiber and amplified. The amplified light circulates in two different directions, clockwise and counterclockwise, in a loop optical path 15. A nonlinear polarization rotator 16 that changes a polarization state of light to control the intensity and phase of the light, and a semiconductor saturable absorber mirror 17 that is a device for generating light pulses are provided on the loop optical path 15. A part of the light circulating clockwise in the loop optical path 15 is extracted by a coupler 18 and is output as the first optical pulse train P1. A part of the light circulating counterclockwise in the loop optical path 15 is extracted by a coupler 19 and is output as the second optical pulse train P2.

As in this modification, the optical pulse train generator may include a dual-comb laser light source. Even in this case, similar effects to those of the respective embodiments can be obtained. A detailed description of the bidirectional-oscillation type dual-comb laser light source is incorporated by reference from the description of Non-Patent Document 4.

In the above example, the nonlinear polarization rotator 16 is used as a mode locking method in the optical pulse train generator 10B, but the present disclosure is not limited thereto. For example, any one of a non-reciprocal phase shifter, a nonlinear loop mirror, and a saturable absorber that absorbs only continuous light and has a high transmittance for pulsed light may be used as a mode locking method. Preferably, a non-reciprocal phase shifter or a saturable absorber that uses a polarization-maintaining fiber that is robust against disturbances may be used as a mode locking method. A gain medium of laser light in the optical pulse train generator 10B is not particularly limited, and may be, for example, erbium, ytterbium, thulium, neodymium and the like.

In this modification, the bidirectional-oscillation type dual-comb laser light source is employed as the optical pulse train generator 10B, but the configuration and the type of the optical pulse train generator 10B are not particularly limited as long as the first optical pulse train P1 and the second optical pulse train P2 can be output. For example, the optical pulse train generator 10B may be a two-unit synchronous type dual-comb laser light source. In this case, it is possible to suppress noise.

Alternatively, the optical pulse train generator 10B may be of a two-unit synchronous type, a machine-shared type, a multi-polarization type, or a microcomb type. A configuration of the two-unit synchronous type dual-comb laser light source is incorporated by reference from the description of Non-Patent Document 12. A configuration of the machine-shared type dual-comb laser light source is incorporated by reference from the description of Non-Patent Document 13. A configuration of the multi-polarization type dual-comb laser light source is incorporated by reference from the description of Non-Patent Document 9. A configuration of the microcomb type dual-comb laser light source is incorporated by reference from the description of Non-Patent Document 14.

The terahertz wave interferometric measurement device and the terahertz wave interferometric measurement method according to the present disclosure are not limited to the above-mentioned embodiments, and various other modifications can be made. For example, in each of the above-mentioned embodiments, the fiber laser is illustrated as the light source of the optical pulse train generator, but the light source is not limited thereto, and may be, for example, a microcomb light source formed by combining a continuous wave (CW) laser, SiN and the like.

[1] A terahertz wave interferometric measurement device according to an aspect of the present disclosure includes an optical pulse train generator, a first converter, a second converter, a wave-combining optical system, a trigger generator, and a detector. The optical pulse train generator outputs a periodic first optical pulse train having a first repetition frequency and a periodic second optical pulse train having a second repetition frequency lower than the first repetition frequency. The first converter converts the first optical pulse train into a first terahertz wave. The second converter converts the second optical pulse train into a second terahertz wave. The wave-combining optical system combines the first terahertz wave and the second terahertz wave to generate a third terahertz wave. The trigger generator generates a trigger signal indicating a timing of detecting the third terahertz wave. The detector includes an electron emitter that receives the third terahertz wave and emits electrons, and an electron multiplier that receives the electrons and emits secondary electrons. The detector detects the third terahertz wave at the timing indicated by the trigger signal.

According to the terahertz wave interferometric measurement device according to [1], dual-comb spectroscopy using terahertz waves can be effectively performed. That is, the first terahertz wave and the second terahertz wave are generated from the first optical pulse train and the second optical pulse train having mutually different repetition frequencies, respectively. Therefore, the first terahertz wave and the second terahertz wave are also different from each other in the pulse repetition frequency. The first terahertz wave and the second terahertz wave are combined by the wave-combining optical system, thereby obtaining the third terahertz wave including a pulse waveform obtained by temporally extending the pulse waveform of the first terahertz wave or the second terahertz wave. Then, the third terahertz wave is detected using the detector capable of detecting the third terahertz wave, in other words, having sensitivity to a wavelength band including a terahertz wave. In this way, it is possible to know a time waveform of a pulse included in the third terahertz wave, and to perform spectroscopic measurement on the object to be measured based on the time waveform. The object to be measured is arranged on an optical path of the first terahertz wave between the first converter and the wave-combining optical system, or on an optical path of the second terahertz wave between the second converter and the wave-combining optical system.

In addition, in the terahertz wave interferometric measurement device according to [1], the detector includes the electron emitter that receives the third terahertz wave and emits electrons, and the electron multiplier that receives the electrons and emits secondary electrons. In this way, it is possible to detect the time waveform of the pulse included in the third terahertz wave in a short time without using a time-consuming conventional method, such as a lock-in amplifier or a thermal detector. Therefore, according to the terahertz wave interferometric measurement device according to [1], a measurement time can be shortened compared to the conventional method.

[2] In the terahertz wave interferometric measurement device according to [1], the detector may have the photomultiplier tube including a plurality of stages of dynodes as the electron multiplier. In this case, when secondary electrons emitted from the dynode at the final stage are converted into a voltage signal, a signal indicating the time waveform of the pulse included in the third terahertz wave can be obtained. Therefore, the time waveform of the pulse included in the third terahertz wave can be detected in a shorter time.

[3] In the terahertz wave interferometric measurement device according to [2], both the first repetition frequency and the second repetition frequency may be within a range from 1 MHz to 1 GHz. When both the first repetition frequency and the second repetition frequency are 1 MHz or more, a measurement time can be sufficiently shortened. Because both the first repetition frequency and the second repetition frequency are 1 GHz or less, the first optical pulse train and the second optical pulse train can be generated using, for example, a fiber laser.

[4] In the terahertz wave interferometric measurement device according to [1], the detector may include an image intensifier and an imager. The image intensifier includes a microchannel plate as the electron multiplier and a phosphor for converting the secondary electrons emitted from the microchannel plate into a fluorescent image. The imager captures the fluorescent image output from the image intensifier. In this case, a signal indicating the time waveform of the pulse included in the third terahertz wave can be obtained two-dimensionally from an optical intensity distribution indicated by image data obtained in the imager. Therefore, spectroscopic measurement for a region having a certain spread in the object to be measured can be performed by a single measurement.

[5] In the terahertz wave interferometric measurement device according to [4], both the first repetition frequency and the second repetition frequency may be within a range from 1 MHz to 500 MHz. When both the first repetition frequency and the second repetition frequency are 1 MHz or more, the measurement time can be sufficiently shortened. Because both the first repetition frequency and the second repetition frequency are 500 MHz or less, the measurement time can be shortened while taking into account the relaxation time of the phosphor.

[6] In the terahertz wave interferometric measurement device according to [1] to [5], the trigger generator may include a nonlinear crystal and a photodetector. The nonlinear crystal generates difference-frequency light or sum-frequency light from the first optical pulse train and the second optical pulse train. The photodetector detects the difference-frequency light or the sum-frequency light from the nonlinear crystal to generate a detection signal. The trigger generator may use the detection signal or a signal based on the detection signal as the trigger signal.

[7] In the terahertz wave interferometric measurement device according to [1] to [6], the difference between the first repetition frequency and the second repetition frequency may be 100 Hz or more. In this case, the measurement time can be sufficiently shortened.

[8] In the terahertz wave interferometric measurement device according to [1] to [7], when the difference between the first repetition frequency frep1 and the second repetition frequency frep2 is set to Δfrep, and a measurement band Δν is defined as Δν=(frep1×frep2)/2Δfrep, the measurement band Δν may be greater than the spectral sensitivity bandwidth of the detector. In this case, the time waveform of the pulse included in the third terahertz wave can be suitably detected.

[9] A terahertz wave interferometric measurement method according to an aspect of the present disclosure includes outputting a periodic first optical pulse train having a first repetition frequency and outputting a periodic second optical pulse train having a second repetition frequency lower than the first repetition frequency, converting the first optical pulse train into a first terahertz wave and converting the second optical pulse train into a second terahertz wave, generating a third terahertz wave by combining the first terahertz wave and the second terahertz wave, generating a trigger signal indicating a timing of detecting the third terahertz wave, and detecting the third terahertz wave at the timing indicated by the trigger signal using a device having an electron emitter for receiving the third terahertz wave and emitting electrons, and an electron multiplier for receiving the electrons and emitting secondary electrons.

According to the terahertz wave interferometric measurement method according to [9], similarly to the terahertz wave interferometric measurement device according to [1], dual-comb spectroscopy using terahertz waves can be effectively performed. In addition, in the terahertz wave interferometric measurement method according to [9], the third terahertz wave is detected using the device having the electron emitter for receiving the third terahertz wave and emitting electrons, and the electron multiplier for receiving the electrons and emitting secondary electrons. In this way, it is possible to detect the time waveform of the pulse included in the third terahertz wave in a short time without using a time-consuming conventional method, such as a lock-in amplifier or a thermal detector. Therefore, according to the terahertz wave interferometric measurement method according to [9], the measurement time can be shortened compared to the conventional method.

What is claimed is:

1. A terahertz wave interferometric measurement device comprising:
an optical pulse train generator configured to output a periodic first optical pulse train having a first repetition frequency and to output a periodic second optical pulse train having a second repetition frequency lower than the first repetition frequency;
a first converter configured to convert the first optical pulse train into a first terahertz wave;
a second converter configured to convert the second optical pulse train into a second terahertz wave;
a wave-combining optical system configured to combine the first terahertz wave and the second terahertz wave to generate a third terahertz wave;
a trigger generator configured to generate a trigger signal indicating a timing of detecting the third terahertz wave; and
a detector having an electron emitter for receiving the third terahertz wave and emitting electrons, and an electron multiplier for receiving the electrons and emitting secondary electrons, and configured to detect the third terahertz wave at the timing indicated by the trigger signal.

2. The terahertz wave interferometric measurement device according to claim 1, wherein the detector includes a photomultiplier tube including a plurality of stages of dynodes as the electron multiplier.

3. The terahertz wave interferometric measurement device according to claim 2, wherein both the first repetition frequency and the second repetition frequency are within a range from 1 MHz to 1 GHz.

4. The terahertz wave interferometric measurement device according to claim 1, wherein the detector comprises:
an image intensifier including a microchannel plate as the electron multiplier and a phosphor for converting the secondary electrons emitted from the microchannel plate into a fluorescent image; and
an imager configured to capture the fluorescent image output from the image intensifier.

5. The terahertz wave interferometric measurement device according to claim 4, wherein both the first repetition frequency and the second repetition frequency are within a range from 1 MHz to 500 MHz.

6. The terahertz wave interferometric measurement device according to claim 1, wherein the trigger generator comprises:
a nonlinear crystal for generating difference-frequency light or sum-frequency light from the first optical pulse train and the second optical pulse train; and
a photodetector configured to detect the difference-frequency light or the sum-frequency light from the nonlinear crystal to generate a detection signal, and
wherein the trigger generator uses the detection signal or a signal based on the detection signal as the trigger signal.

7. The terahertz wave interferometric measurement device according to claim 1, wherein a difference between the first repetition frequency and the second repetition frequency is 100 Hz or more.

8. The terahertz wave interferometric measurement device according to claim 1, wherein, when a difference between the first repetition frequency frep1 and the second repetition frequency frep2 is set to Δfrep, and a measurement band Δν is defined as Δν=(frep1×frep2)/2Δfrep, the measurement band Δν is greater than a spectral sensitivity bandwidth of the detector.

9. A terahertz wave interferometric measurement method comprising:
outputting a periodic first optical pulse train having a first repetition frequency and outputting a periodic second optical pulse train having a second repetition frequency lower than the first repetition frequency;
converting the first optical pulse train into a first terahertz wave and converting the second optical pulse train into a second terahertz wave;
generating a third terahertz wave by combining the first terahertz wave and the second terahertz wave;
generating a trigger signal indicating a timing of detecting the third terahertz wave; and
detecting the third terahertz wave at the timing indicated by the trigger signal using a device having an electron emitter for receiving the third terahertz wave and emitting electrons, and an electron multiplier for receiving the electrons and emitting secondary electrons.

10. The terahertz wave interferometric measurement method according to claim 9, wherein in the detecting, a photomultiplier tube including a plurality of stages of dynodes is used as the electron multiplier.

11. The terahertz wave interferometric measurement method according to claim 10, wherein both the first repetition frequency and the second repetition frequency are within a range from 1 MHz to 1 GHz.

12. The terahertz wave interferometric measurement method according to claim 9, wherein the device used in the detecting comprises:
an image intensifier including a microchannel plate as the electron multiplier and a phosphor for converting the secondary electrons emitted from the microchannel plate into a fluorescent image; and
an imager configured to capture the fluorescent image output from the image intensifier.

13. The terahertz wave interferometric measurement method according to claim 12, wherein both the first repetition frequency and the second repetition frequency are within a range from 1 MHz to 500 MHz.

14. The terahertz wave interferometric measurement method according to claim 9, wherein the generating the trigger signal comprises:
generating difference-frequency light or sum-frequency light from the first optical pulse train and the second optical pulse train using a nonlinear crystal; and
detecting the difference-frequency light or the sum-frequency light from the nonlinear crystal to generate a detection signal, and
wherein the detection signal or a signal based on the detection signal is used as the trigger signal.

15. The terahertz wave interferometric measurement method according to claim 9, wherein a difference between the first repetition frequency and the second repetition frequency is 100 Hz or more.

16. The terahertz wave interferometric measurement method according to claim 9, wherein, when a difference between the first repetition frequency frep1 and the second repetition frequency frep2 is set to Δfrep, and a measurement band Δν is defined as Δν=(frep1×frep2)/2Δfrep, the measurement band Δν is greater than a spectral sensitivity bandwidth of the device.
